(19) United States
(12) Patent Application Publication
(10) Pub. No.: US 2025/0042698 A1
(43) Pub. Date: Feb. 6, 2025

(54) COMB PLATE FOR CONVEYOR DEVICE, AND CONVEYOR DEVICE

(71) Applicant: Otis Elevator Company, Farmington, CT (US)

(72) Inventors: Xiren Hu, Hangzhou (CN); Kiyomoto Koji, Tomisato-shi (JP)

(21) Appl. No.: 18/779,753

(22) Filed: Jul. 22, 2024

(30) Foreign Application Priority Data
Jul. 31, 2023 (CN) 202310953100.5

(51) Int. Cl. B66B 29/06; B66B 21/04; B66B 21/10

(52) U.S. Cl. CPC B66B 29/06; B66B 21/04; B66B 21/10

(57) ABSTRACT

A comb plate for a conveyor device, the comb plate is provided with a plurality of teeth arranged across the width of the conveyor belt of the conveyor device and substantially parallel to each other, each of the plurality of teeth fits into a corresponding groove arranged on steps of the conveyor belt during operation, and the comb plate includes a plurality of rollers arranged at the front parts of at least some teeth.

### FOREIGN PRIORITY

This application claims priority to Chinese Patent Application No. 202310953100.5, filed Jul. 31, 2023, and all the benefits accruing therefrom under 35 U.S.C. § 119, the contents of which in its entirety are herein incorporated by reference.

### TECHNICAL FIELD OF INVENTION

The present application relates to a conveyor device, in particular to technologies related to comb plates.

### BACKGROUND OF THE INVENTION

Comb plates are installed at the entrance and exit of an escalator or a moving walk, with its teeth having a shape and slope that will not trip passengers when they leave the escalator or moving walk. One end of the comb plate is supported on the leading edge plate, and the end with teeth meshes with the steps (or tread plates) in a staggered manner during the operation of the escalator or moving walk. If a foreign object is trapped in the area where the steps mesh with the comb teeth, it will prevent the steps from meshing with the comb plate normally, which may cause the comb teeth to bend or break. If the steps still cannot enter the comb plate at this point, it will cause damage to important components. Taking the escalator as an example, it is configured with a foreign object protection device for the comb plate. However, the existing foreign object protection devices mainly apply emergency braking to the escalator by triggering switches to disconnect the electrical circuit in the case that a foreign object is stuck and cannot be removed.

In addition, the teeth of the comb plate are made of materials that are usually relatively weak in rigidity, so the teeth are prone to bending when being stepped on or being subjected to other large forces. The bending of the teeth can also affect the meshing between the comb plate and the steps, which may cause damage to the components and in some cases, may also affect the safety of passengers.

### SUMMARY OF THE INVENTION

The present application provides a comb plate for a conveyor device, so as to make improvements to at least one of the above problems.

According to one aspect of the present application, a comb plate for a conveyor device is provided, wherein the comb plate is provided with a plurality of teeth, which are arranged across the width of a conveyor belt of the conveyor device and are substantially parallel to each other, where each of the plurality of teeth fits into a corresponding groove arranged on steps of the conveyor belt during operation, and the comb plate further comprises: a plurality of rollers arranged at the front parts of at least some teeth.

For the comb plate for a conveyor device, additionally or as an alternative, the plurality of rollers are arranged in grooves at the front parts of the at least some teeth.

For the comb plate for a conveyor device, additionally or as an alternative, each of the grooves is provided with: a first roller fixed to the groove in a rotatable manner, where the first roller is configured, when the tooth in which it is arranged fits into the corresponding groove, to contact with and driven by the bottom of the corresponding groove to rotate in a first direction; and a second roller fixed in the groove in a position closer to the steps in a rotatable manner, and configured to contact with and driven by the first roller to rotate in a second direction opposite to the first direction.

For the comb plate for a conveyor device, additionally or as an alternative, the second roller is configured not to contact with the bottom of the corresponding groove when the tooth in which it is arranged fits into the corresponding groove.

For the comb plate for a conveyor device, additionally or as an alternative, the groove is configured to partially expose the second roller.

For the comb plate for a conveyor device, additionally or as an alternative, the first roller is made of elastic material, and the second roller is made of rigid material.

For the comb plate for a conveyor device, additionally or as an alternative, the diameter of the second roller is greater than the clearance between adjacent steps in the steps.

For the comb plate for a conveyor device, additionally or as an alternative, each of the plurality of teeth is provided with the first roller and the second roller.

For the comb plate for a conveyor device, additionally or as an alternative, the plurality of rollers are arranged on a bracket located under the front parts of the teeth, where the bracket is rotatable along an axis in the width direction of the conveyor belt.

For the comb plate for a conveyor device, additionally or as an alternative, the comb plate further comprises a reset spring member, where the reset spring member is configured to reset the bracket after rotation.

For the comb plate for a conveyor device, additionally or as an alternative, the reset spring member comprises: a frame comprising at least two longitudinal arms arranged along the length direction of the conveyor belt that is connected to the bracket; a plate part fixed to the comb plate; a shaft part comprising a box body and a shaft, where the shaft passes through the box body, ends of the shaft are connected to the longitudinal arms, and the box body is fixed to the plate part; and an spring component, with one end thereof fixed to the plate part, and the other end arranged at an end of the shaft, fixed by the longitudinal arms and the box body in the length direction of the shaft.

For the comb plate for a conveyor device, additionally or as an alternative, the spring component is constructed as a torsion spring, where the body of the torsion spring is arranged at the end of the shaft.

For the comb plate for a conveyor device, additionally or as an alternative, the plurality of rollers are spaced at least one tooth apart from each other, and the front parts of the teeth corresponding to the positions of the rollers are arranged to partially expose the rollers.

For the comb plate for a conveyor device, additionally or as an alternative, the front parts of the teeth between the rollers are each provided with a concave part for accommodating the bracket.

A conveyor device is further provided, which comprises: a truss; a conveyor belt comprising a plurality of steps; a first floor plate and a second floor plate arranged at both ends of the conveyor belt, where the first floor plate and the second floor plate are each provided with a comb plate according to any of the above examples in a transition area with the steps.

In the above examples, the conveyor device can be an escalator, a moving walk, and other conveyor devices for transporting people and/or goods.

### BRIEF DESCRIPTION OF THE DRAWINGS

The embodiments of the present application will be described in detail below in conjunction with the accompanying drawings, so that the present application can be fully understood, where:

FIG. 1 is a schematic diagram of an escalator 10;

FIG. 2 is a schematic diagram of the general structure of an escalator;

FIG. 3 illustrates an enlarged structural diagram of the landing area 7 that is not shown in FIG. 2;

FIG. 4 is a structural schematic diagram of a tooth of a comb plate according to an embodiment of the present application;

FIG. 5 is a side view of the tooth and the corresponding groove shown in FIG. 4;

FIGS. 6A to 6C illustrate the scenario of a passenger stepping on the comb plate;

FIG. 6D illustrates the state when the entire foot 50 transitions to the comb plate;

FIGS. 7A to 7C illustrate the process of handling a small object falling into the groove of the steps;

FIG. 8 illustrates the relationship between the width D of the clearance between adjacent steps and the rollers;

FIG. 9 is a structural schematic diagram of a comb plate according to another embodiment of the present application;

FIG. 10A is a schematic diagram of an existing comb plate;

FIG. 10B is a schematic diagram of the comb plate shown in FIG. 9;

FIG. 11 illustrates the structure of a specific example of a reset spring member;

FIG. 12 is an exploded view of the reset spring member;

FIG. 13 is a schematic diagram of a reset spring member already installed with rollers being mounted to the comb plate; and

FIGS. 14A to 14C illustrate the scenario of a passenger stepping on the comb plate according to the embodiment.

### DETAILED DESCRIPTION OF THE INVENTION

To assist those skilled in the art to gain a precise understanding of the subject matter claimed by the present application, the specific embodiments of the present application will be described in detail below in conjunction with the accompanying drawings.

The terms “first”, “second”, etc. in the description, claims, and accompanying drawings of the present application are used to distinguish similar objects, rather than to describe a specific order or sequence thereof. It should be appreciated that the numbers used in this way can be interchanged with each other in appropriate cases, so that the embodiments of the invention described herein can be implemented in orders other than those illustrated or described herein. In addition, “first” and “second” are only used for descriptive purposes, and cannot be understood as indicating or implying relative importance or implying or indicating the quantity of technical features indicated. Therefore, the features defined with “first” and “second” can explicitly or implicitly include one or more of such features. In the depiction of the embodiments of the present application, unless otherwise stated, “a plurality of” means two or more.

The terms “example”, “as an example”, or “illustratively”, used in the following text mean “used as an example, embodiment, or illustration”. Any embodiment depicted as an “example”, or “as an example” or “illustratively” need not be interpreted as being superior or better than other embodiments.

The conveyor devices according to the present application may include escalators, travelators, and other conveyor devices for transporting passengers and/or goods. Wherein, a travelator may also be referred to as a moving walk, and a conveyor device may also be referred to as a conveying device, a conveying system, a conveyor system, a passenger conveyor, a passenger conveyor system, and the like. Although the following embodiments of the present application all use examples of escalators being used as conveyor devices to describe the present application, it should be appreciated, however, that the various examples of the comb plate described in conjunction with an escalator in the present application can be applied to other conveyor devices or conveyor systems, such as moving walks.

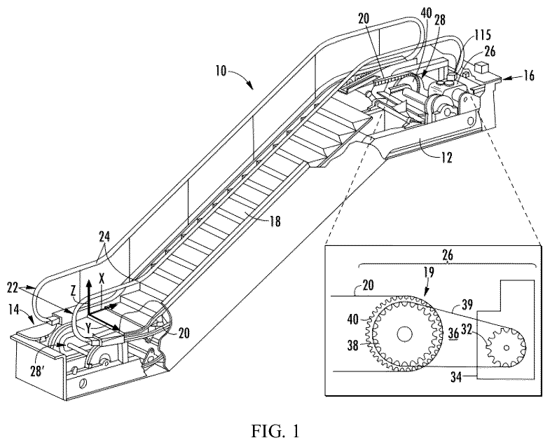

FIG. 1 illustrates an escalator 10. It should become apparent in the ensuing description that the present invention is applicable to other passenger conveyor systems, such as moving walks. The escalator 10 generally includes a truss 12 extending between a lower landing 14 and an upper landing 16. A plurality of sequentially connected steps or tread plates 18 are connected to a step chain 20 and travel through a closed loop path within the truss 12. A pair of balustrades 22 includes moving handrails 24. A drive machine 26, or drive system, is typically located in a machine space 28 under the upper landing 16; however, an additional machine space 28′ can be located under the lower landing 14. The drive machine 26 is configured to drive the tread plates 18 and/or handrails 24 through the step chain 20. The drive machine 26 operates to move the tread plates 18 in a chosen direction at a desired speed under normal operating conditions.

The tread plates 18 make a 180 degree heading change in a turn-around area 19 located under the lower landing 14 and upper landing 16. The tread plates 18 are pivotally attached to the step chain 20 and follow a closed loop path of the step chain 20, running from one landing to the other, and back again.

The drive machine 26 includes a first drive member 32, such as motor output sheave, connected to a drive motor 34 through a belt reduction assembly 36 including a second drive member 38, such as an output sheave, driven by a tension member 39, such as an output belt. The first drive member 32 in some embodiments is a driving member, and the second drive member 38 is a driven member.

As used herein, the first drive member 32 and/or the second drive member 38, in various embodiments, may be any type of rotational device, such as a sheave, pulley, gear, wheel, sprocket, cog, pinion, etc. The tension member 39, in various embodiments, can be configured as a chain, belt, cable, ribbon, band, strip, or any other similar device that operatively connects two elements to provide a driving force from one element to another. For example, the tension member 39 may be any type of interconnecting member that extends between and operatively connects the first drive member 32 and a second drive member 38. In some embodiments, as shown in FIG. 1, the first drive member 32 and the second drive member may provide a belt reduction. For example, first drive member 32 may be approximately 75 mm (2.95 inches) in diameter while the second drive member 38 may be approximately 750 mm (29.53 inches) in diameter. The belt reduction, for example, allows the replacement of sheaves to change the speed for 50 or 60 Hz electrical supply power applications, or different step speeds. However, in other embodiments the second drive member 38 may be substantially similar to the first drive member 32.

As noted, the first drive member 32 is driven by drive motor 34 and thus is configured to drive the tension member 39 and the second drive member 38. In some embodiments, the second drive member 38 may be an idle gear or similar device that is driven by the operative connection between the first drive member 32 and the second drive member 38 by means of tension member 39. The tension member 39 travels around a loop set by the first drive member 32 and the second drive member 38, which hereinafter may be referred to as a small loop. The small loop is provided for driving a larger loop which consists of the step chain 20, and is driven by an output sheave 40, for example. Under normal operating conditions, the tension member 39 and the step chain 20 move in unison, based upon the speed of movement of the first drive member 32 as driven by the drive motor 34.

The escalator 10 also includes a controller 115 that is in electronic communication with the drive motor 34. The controller 115 may be located, as shown, in the machine space 28 of the escalator 10 and is configured to control the operation of the escalator 10. For example, the controller 115 may provide drive signals to the drive motor 34 to control the acceleration, deceleration, stopping, etc. of the tread plates 18 through the step chain 20. The controller 115 may be an electronic controller including a processor and an associated memory comprising computer-executable instructions that, when executed by the processor, cause the processor to perform various operations. The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

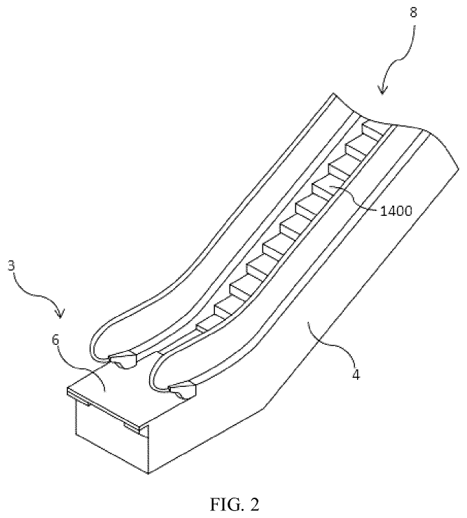

FIG. 2 is a schematic diagram of the general structure of an escalator according to some examples of the present application. As shown in FIG. 2, the escalator includes a truss 4 extending between a lower landing 3 comprising a floor plate 6 and a corresponding upper landing (not shown). A plurality of steps 1400 constitute a step chain, also known as a conveyor belt 8. The floor plate 6 may also be referred to as a cover plate in some cases.

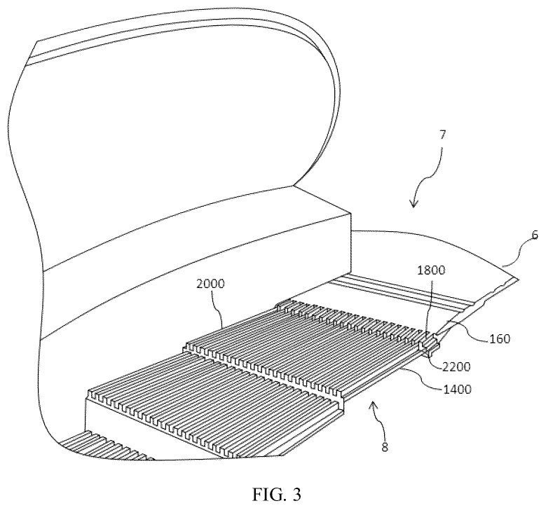

FIG. 3 illustrates an enlarged structural diagram of an upper landing 7 not shown in FIG. 2. As shown in FIG. 3, a step 1400 of the conveyor belt 8 or the step chain 8 is provided with a plurality of alternately arranged slats 2000 and tread grooves 2200 extending in the longitudinal direction (conveying direction). A comb plate 160 is arranged tightly against a floor plate 6 on the side facing the step chain 8. The comb plate 160 includes a plurality of teeth 1800 extending in the longitudinal direction, which are in a staggered relation with the slats 2000 of the step 1400 and extend into the tread grooves 2200. In other words, during the operation of the escalator, the slats 2000 of the step 1400 and the teeth 1800 of the comb plate 160 move in a staggered manner, where the teeth 1800 of the comb plate 160 fit into their corresponding tread grooves 2200 when meshing with the slats 2000.

The comb plate according to the present application also includes a plurality of rollers, where the rollers are arranged in at least some of the plurality of teeth. According to the present application, the rollers are arranged at the front parts of at least some teeth. In some examples, each tooth is provided with a roller. In some other examples, only some teeth are provided with rollers. As an example without limitation, the rollers are arranged in the grooves at the front parts of the teeth on which they are located, that is, during the process of the plurality of teeth moving in a staggered manner with the slats of the steps, the rollers of the teeth provided with rollers move in a staggered manner with the corresponding slats.

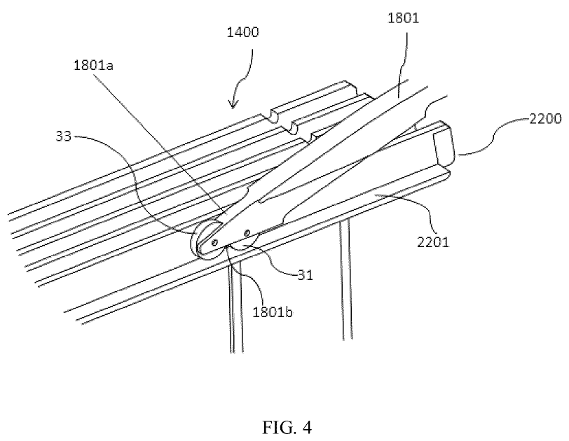

FIG. 4 is a structural schematic diagram of a tooth of a comb plate according to an embodiment of the present application. In this embodiment, one tooth 1801 among a plurality of teeth 1800 (see FIG. 3) is used as an example to illustrate the structure of the tooth of the comb plate according to this embodiment. The front part 1801a of the tooth 1801 is provided with a groove 1801b, where the rollers are arranged in the groove 1801b. In this example, a first roller 31 and a second roller 33 are arranged in the groove 1801b.

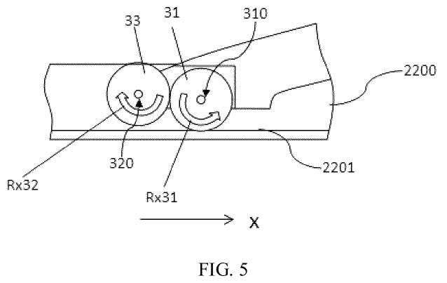

The first roller 31 is arranged in the groove 1801b. The first roller 31 is fixed in the groove 1801b in a rotatable manner, and is in contact with the bottom 2201 of the groove 2200 fit with it on the step 1400. In this way, when the step 1400 moves in the conveying direction, it drives the first roller 31 to rotate. FIG. 5 is a side view of the tooth and its corresponding groove shown in FIG. 4. As shown in FIG. 5, when the step moves in the conveying direction x, it drives the first roller 31 to rotate in the rotation direction Rx31 indicated by the arrow.

The second roller 33 is fixed in the groove 1801b in a rotatable manner (see FIG. 4), and is configured to contact with the first roller 31 so as to be driven by the first roller 31 to rotate. In the example of the present application, the second roller 33 is configured to be driven by the first roller 31 to rotate, so the rotation direction of the second roller 33 is opposite to the rotation direction of the first roller 31. Specifically, the second roller 33 rotates in the direction Rx32 as indicated by the arrow in FIG. 5. As an example, the second roller 33 does not contact with the bottom 2201 of the corresponding groove 2200.

According to some examples of the present application, the first roller 31 is made of an elastic material, such as rubber. In some cases, as an example without limitation, the second roller 33 may be made of a rigid material, such as a rigid metal material. The first roller 31 made of elastic material can increase the friction force between the roller and the bottom 2201 of the corresponding groove 2200, which helps the first roller 31 roll due to the friction with the bottom 2201. The second roller 33 is in contact with the first roller 31 made of elastic material, and is driven by the latter to roll. The second roller 33 made of rigid material is more wear-resistant. It should be noted that the materials of the first and second rollers can be selected according to actual needs, and are not limited to what is illustrated in the present application.

According to some examples of the present application, the first roller 31 is arranged on a shaft 310, where the shaft 310 is fixed in the groove 1801b (indicated in FIG. 4). The first roller 31 is, for example, a bearing or other rolling element that can be constructed to be fixed in the groove 1801b in a rolling manner under the driving force of the corresponding groove 2200.

According to some examples of the present application, the second roller 33 is arranged on a shaft 320, where the shaft 320 is fixed in the groove 1801b (indicated in FIG. 4). The second roller 33 is, for example, a bearing or other rolling element that can be constructed to be fixed in the groove 1801b in a rolling manner under the driving force of the corresponding groove 2200. It should be noted that both the first roller 31 and the second roller 33 can be bearings, or one can be a bearing and the other can be other rolling element, or both can be other rolling elements, as long as the rotation of the first roller 31 can drive the second roller 33 to rotate.

According to some examples of the present application, the groove 1801b of the tooth 1801 is configured to partially expose the second roller 33. As shown in FIGS. 4 and 5, when the tooth 1801 extends into the corresponding groove 2200, the first roller 31 rotates in the direction Rx31, and the second roller 33 rotates in the direction Rx32. During this process, the first roller 31 is arranged in the groove 1801b farther away from the step and located inside the tooth 1801 all the time, and the second roller 33 is arranged in the position of the tooth 1801 closest to the step and maintains the state of partially exposing the front part 1801a of the tooth 1801.

According to an embodiment of the present application, a first roller and a second roller can be arranged at the front part of each tooth of the plurality of teeth of the comb plate. That is, each tooth of the comb plate can be configured as the tooth 1801 shown in the combination of FIGS. 4 and 5, for example. As an alternative, the first and second rollers can also be arranged only in some teeth.

After the comb plate with the teeth shown in FIGS. 4 and 5 is applied to an escalator, when a passenger steps on the comb plate, the passenger's shoe will first come into contact with the second roller 33. The second roller 33, driven by the first roller 31, rolls, and under the action of the first roller 31 and the second roller 33, the passenger's shoe is lifted up and the passenger is made to continue to move forward, thus effectively avoiding the case of the comb teeth being pressed down to deformation by the passenger.

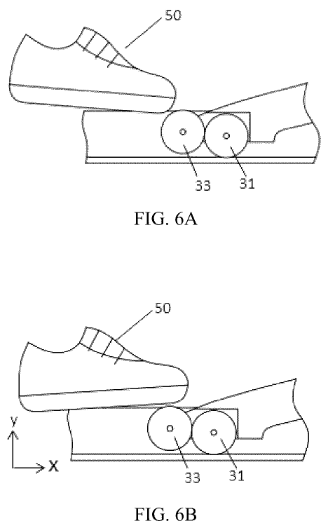

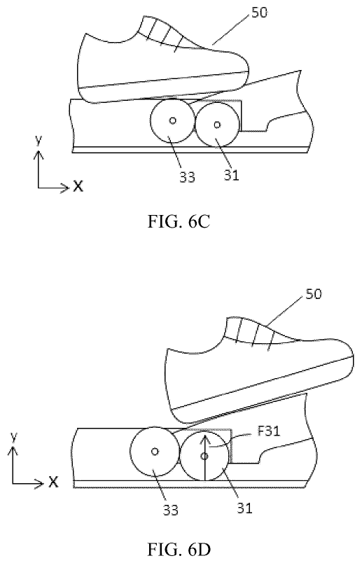

FIGS. 6A to 6C illustrate the scenario of a passenger stepping on the comb plate. As shown in FIG. 6A, a passenger is taking a running escalator, the passenger's foot 50 first comes into contact with the second roller 33 when the steps join with the teeth of the comb plate. The second roller 33 is driven by the first roller 31 to move in the direction Rx32 (see FIG. 5), which is consistent with the running direction x (see FIG. 5) of steps 1400 from the perspective of the passenger. As the escalator moves, the passenger's foot 50 advances from the position where it just comes into contact with the second roller 33 in FIG. 6A to the position where the fore sole steps on the second roller 33 as shown in FIG. 6B. During this process, the second roller 33 slightly lifts the passenger's foot 50 to land smoothly on the comb plate, as shown in FIG. 6C. During this process, the second roller 33, which is elastic and fixed in the groove, while rotating, always applies an upward (y-direction) force to the foot 50 after the foot 50 comes into contact with it, avoiding the comb teeth from bending down to deformation due to stepping of foot 50, thus effectively avoiding safety hazards caused by teeth deformation. FIG. 6D illustrates the state when the entire foot 50 transition to the comb plate. At this point, the upward support force F31 of the first roller 31 helps to prevent the foot 50 from stepping on the comb plate to cause tooth deformation. In the examples illustrated in FIGS. 6A to 6D, the passenger's foot 50 is only a specific example of various objects that can act on the comb plate to cause deformation, rather than a limitation, while such objects can be, for example, a passenger's crutch (in the case where a crutch is used).

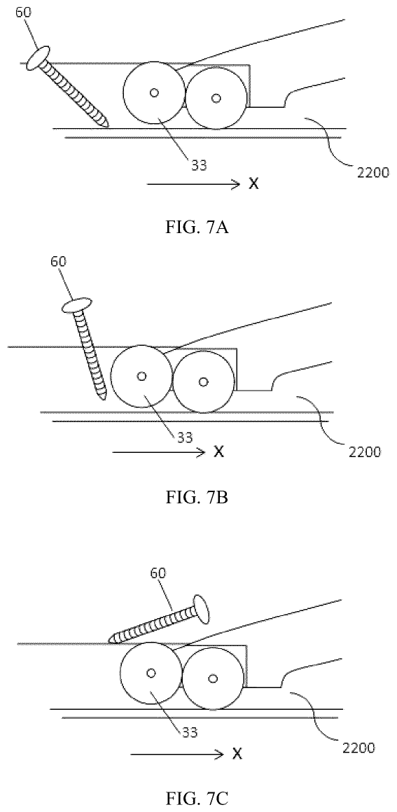

On the other hand, when the comb plate with the teeth described in conjunction with FIGS. 4 and 5 is applied to an escalator, it can also effectively prevent foreign objects from getting stuck between the comb plate and the steps. FIGS. 7A to 7C illustrate the process of handling a small object falling into the groove of the steps. In FIG. 7A, a small object, i.e., a nail 60, falls into the groove 2200. As the step moves in the x-direction, it first comes into contact with the second roller 33, as shown in FIG. 7B. The roller 33, which rotates in the direction Rx32 (see FIG. 5), lifts the nail, and finally, as shown in FIG. 7C, pushes the nail out of the groove 2200.

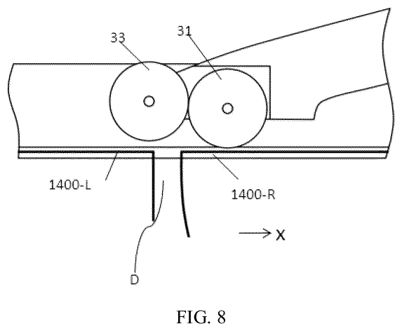

Furthermore, when the comb plate with the teeth described in conjunction with FIGS. 4 and 5 is applied to the escalator, as the diameter of the second roller 33 is greater than the clearance between adjacent steps, it can also effectively avoid contact between the teeth of the comb plate and the steps. For example, as shown in FIG. 8, the left step 1400-L and the right step 1400-R are steps adjacent to each other, and the width D of the clearance between the two is smaller than the diameter of the second roller 33. Therefore, due to the second roller 33, the heads of the teeth of the comb plate will never collide or strike the steps during the movement of the steps in the X direction.

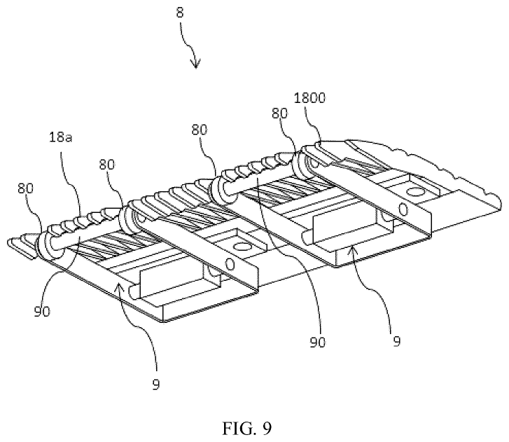

FIG. 9 is a structural schematic diagram of a comb plate according to another embodiment of the present application. In this embodiment, the comb plate 8 includes a plurality of rollers 80. The plurality of rollers 80 are arranged on brackets 90 below the front parts of at least some teeth 1800. The bracket 90 is arranged below the front parts of the teeth in a way that can rotate along the axis in the width direction of the conveyor belt.

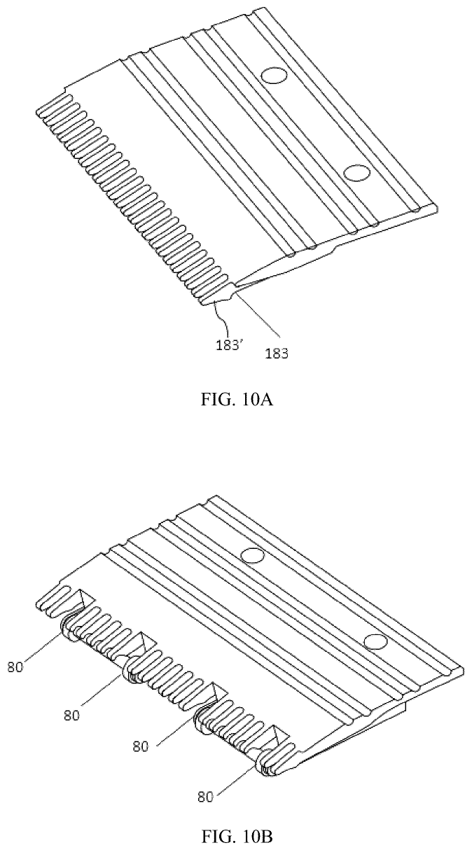

In some examples, the rollers 80 are spaced at least one tooth apart from each other. In the example shown in FIG. 9 of the present application, two rollers spaced 4 or 5 teeth apart from each other are arranged on a bracket 90, and two brackets 90 are arranged below the teeth of the comb plate. However, this is an example and the real situations are not limited to this. According to an example of the present application, the front parts of the teeth used to arrange the rollers corresponding to the positions of the rollers are configured to partially expose the rollers. FIG. 10A is a schematic diagram of an existing comb plate. FIG. 10B is a schematic diagram of the comb plate shown in FIG. 9. The front parts of some teeth used to arrange the rollers in FIG. 10B are not constructed into the shape of the front parts of the existing teeth, that is, not constructed into the existing “tooth-like” shape of the front part 183′ of, for example, a tooth 183, in FIG. 10A, but are respectively arranged with rollers 80.

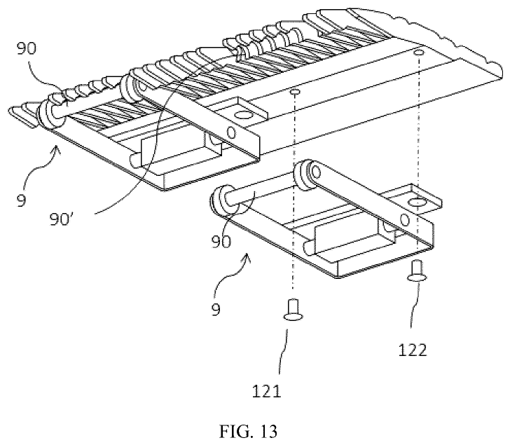

Returning to FIG. 9, the lower parts of the teeth between the two rollers 80 are constructed with concave parts 90′ (see FIG. 13 below) to accommodate the bracket 90. The bracket 90 is connected to a reset spring member 9, which is configured to reset the bracket 90 after rotation.

According to an example of the present application, the reset spring member 9 includes a frame connecting the bracket 90, where the frame includes a plurality of longitudinal arms, for example, at least two longitudinal arms, and in some cases, three or four. The longitudinal arms are arranged along the length direction of the conveyor belt. The bracket 90 is connected to the frame by passing through one end of the longitudinal arms. The reset spring member 9 also includes a plate part, a shaft part, and an spring component. The plate part is fixed to the comb plate. The shaft part includes a box body and a shaft, where the shaft passes through the box body, the ends of the shaft are connected to the longitudinal arms, and the box body is fixed to the plate part. One end of the spring component is fixed to the plate, and the other end is arranged at the end of the shaft and is fixed along the length direction of the shaft by the longitudinal arms and the box body.

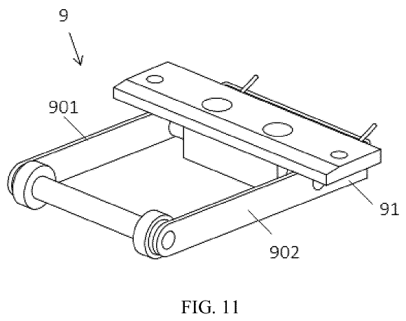

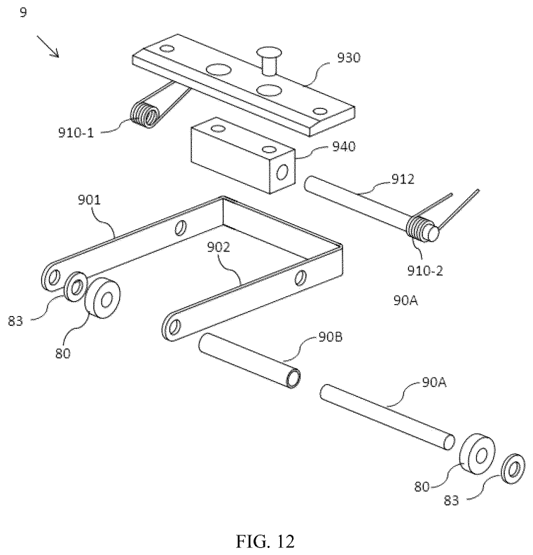

FIG. 11 illustrates the structure of a specific example of a reset spring member 9. FIG. 12 is an exploded view of the reset spring member 9. Referring to both FIGS. 11 and 12, the frame of the reset spring member 9 includes a first longitudinal arm 901, a second longitudinal arm 902, a transverse arm (not indicated) connecting the two longitudinal arms 901 and 902, a plate part 930, a shaft part 91, and an spring component. The two ends of the bracket 90 are respectively connected to one end of the first longitudinal arm 901 and that of the second longitudinal arm 902 of the frame of the reset spring member 9, and the other end of the first longitudinal arm 901 and that of the second longitudinal arm 902 are connected through the transverse arm of the frame. The shaft part 91 includes a box body 940 and a shaft 912, where the shaft 912 can pass through the box body 940 and the two ends of the shaft 912 can be connected to the first longitudinal arm 901 and the second longitudinal arm 902, respectively. The torsion spring in this example, which serves as an spring component, includes a first torsion spring 910-1 and a second torsion spring 910-2.

According to some specific examples of the present application, the torsion spring body (spring coil) of the first torsion spring 910-1 is arranged between the first longitudinal arm 901 and the box body 940 through the shaft 912, and the torsion spring body (spring coil) of the second torsion spring 910-2 is arranged between the second longitudinal arm 902 and the box body 940. In this way, the first torsion spring 910-1 cannot move along the length direction of the axis 912 due to the first longitudinal arm 901 and the box body 940 arranged on both sides. Similarly, the second torsion spring 910-2 cannot move along the length direction of the axis 912 due to the second longitudinal arm 902 and the box body 940 on both sides. The other end of the first torsion spring 910-1 and that of the second torsion spring 910-2 are both fixed to the plate part 930, while the plate part 930 is fixed to the comb plate and at the same time combined with the box body 940 through, for example, screws, so that the box body 940 is fixed to the comb plate through the plate part 930. The shaft 912 passes through the box body 940 and can rotate inside the box body 940.

With continued reference to FIG. 12, the bracket 90 may include a circular inner bracket 90B made of, for example, a rigid material (such as a rigid metal material) and an outer bracket 90A made of, for example, a rigid material (such as a rigid metal material) for accommodating the inner bracket 90B. The rollers 80 are arranged at both ends of the outer bracket 90. A gasket 83 can be arranged between the two rollers 80 and the longitudinal arms 901 and 902, respectively.

FIG. 13 is a schematic diagram of the reset spring member 9 already installed with rollers being mounted to the comb plate. As shown in FIG. 13, the reset spring member 9 is mounted to the comb plate through a first screw 121 and a second screw 122, wherein the bracket 90 will be arranged in the concave parts 90′ accordingly.

Returning to FIG. 9, the roller 80 is respectively fixed by the first longitudinal arm 901 or the second longitudinal arm 902 and the adjacent tooth on the other side of the roller 80 in the width direction of the comb plate (after the comb plate is installed on the escalator, the width direction of the comb plate is also the width direction of the conveyor belt). The roller 80 itself can rotate around the bracket 90, while the bracket 90, driven by the reset spring member 9, can rotate around the axis 912 in the width direction of the comb plate.

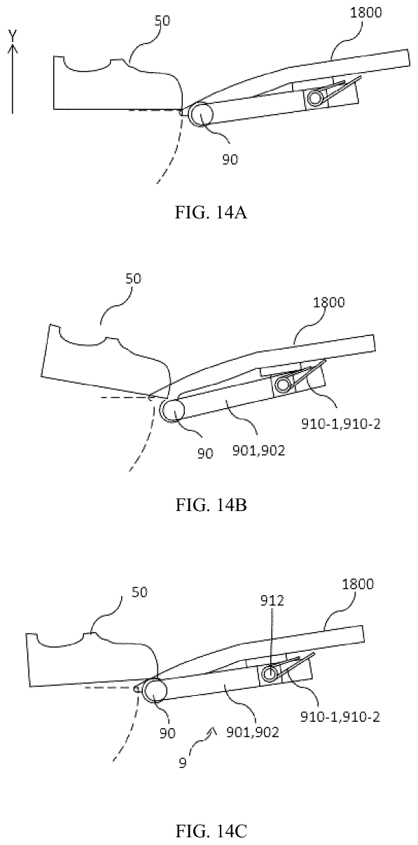

After the comb plate shown in FIG. 9 is installed on the escalator, when a passenger's foot steps on the meshing position between the comb plate and the steps, it will be immediately ejected upward, so as to avoid accidents. FIGS. 14A to 14C illustrate the scenario of a passenger stepping on the comb plate according to this embodiment. As shown in FIG. 14A, a passenger is taking a running escalator. When the step joins with the teeth of the comb plate, the passenger's foot 50 begins to press down the teeth 1800 (in the opposite direction of the Y direction) as soon as it comes into contact with the forefront of the teeth 1800. As the step (not indicated) moves forward, the passenger's foot 50 will move above the bracket 90 and push the bracket 90 downwards (in the opposite direction of the Y direction) through the teeth, as shown in FIG. 14B. At this point, the force exerted on the bracket 90 acts on the torsion springs (910-1, 910-2) through the longitudinal arms (901, 902), so the torsion springs generate a torsion force, causing the reset spring member 9 to rotate upwards along the axis 912. The bracket 90 is driven to lift the passenger's foot 50 upwards (generally in the Y direction), thereby avoiding the deformation of the teeth 1800 due to compression.

In the various examples of the reset spring member 9 described above in conjunction with FIGS. 11 and 12, the first longitudinal arm 901 and the second longitudinal arm 902 can be made of the same material or of different materials, for example, both can be made of rigid metal materials. The plate part 930, box body 940, and shaft 912 can all be made of rigid metal materials, and the roller 80 can be a bearing or other components that are rotatable.

The comb plate according to the present application may only include rollers arranged in the way described in conjunction with FIGS. 9 to 13, or only include rollers arranged in the way described in conjunction with FIGS. 4 and 5, or include rollers arranged in both ways at the same time.

The present application also provides a conveyor device, such as an escalator or a moving walk. The conveyor device includes a truss, a conveyor belt comprising a plurality of steps, and one of the comb plates described in the various examples of the present application, which is arranged in the transition area between the first floor plate and the second floor plate at both ends of the conveyor belt and the steps. The first floor plate and the second floor plate are, for example, the floor plates arranged on the upper landing and the lower landing, as described above in conjunction with the appended drawings.

Without contradiction or conflict, the technical features in the various examples described herein can be combined with each other to form embodiments not described herein, which should also be covered by the scope of the present application.

By using the comb plate according to any example of the present application, in the process of the conveyor belt of an escalator or a moving walk meshing with the comb plate, deformation of comb plate teeth caused by the down force from feet of passengers riding on the conveyor device can be effectively avoided, thereby preventing potential hazards. In addition, some examples can also effectively push out objects that fall into the clearance of the steps and comb plate through the rotation of the rollers, avoiding damage to the comb teeth, thereby avoiding safety hazards due to comb teeth damage, and at the same time, more effectively ensuring the safety of elevator passengers.

Although specific embodiments of the present application have been shown and described in detail to illustrate the principle of the present application, it should be understood, however, that the present application may be implemented in other ways without departing from the principle.

What is claimed is:

1. A comb plate for a conveyor device, wherein the comb plate is provided with a plurality of teeth arranged across a width of a conveyor belt of the conveyor device and substantially parallel to each other, where each of the plurality of teeth fits into a corresponding groove arranged on steps of the conveyor belt during operation, and the comb plate further comprises: a plurality of rollers arranged at front parts of at least some teeth.

2. The comb plate according to claim 1, wherein the plurality of rollers are arranged in grooves at the front parts of the at least some teeth.

3. The comb plate according to claim 2, wherein each of the grooves is provided with:
a first roller fixed in the groove in a rotatable manner, where the first roller is configured, when the tooth in which it is arranged fits into the corresponding groove, to contact with and driven by the bottom of the corresponding groove to rotate in a first direction; and
a second roller fixed in the groove in a position closer to the step in a rotatable manner, and configured to contact with and driven by the first roller to rotate in a second direction opposite to the first direction.

4. The comb plate according to claim 3, wherein the second roller is configured not to contact with the bottom of the corresponding groove when the tooth in which it is arranged fits into the corresponding groove.

5. The comb plate according to claim 3, wherein the groove is configured to partially expose the second roller.

6. The comb plate according to claim 3, wherein the first roller is made of elastic material, and the second roller is made of rigid material.

7. The comb plate according to claim 3, wherein a diameter of the second roller is greater than a clearance between adjacent steps.

8. The comb plate according to claim 3, wherein each of the plurality of teeth is provided with the first roller and the second roller.

9. The comb plate according to claim 1, wherein the plurality of rollers are arranged on brackets located under the front parts of the teeth, where the bracket is rotatable along an axis in the width direction of the conveyor belt.

10. The comb plate according to claim 9, wherein the comb plate further comprises a reset spring member, where the reset spring member is configured to reset the bracket after rotation.

11. The comb plate according to claim 10, wherein the reset spring member comprises:
a frame comprising at least two longitudinal arms arranged along the length direction of the conveyor belt that is connected to the bracket;
a plate part fixed to the comb plate;
a shaft part comprising a box body and a shaft, wherein the shaft passes through the box body, ends of the shaft are connected to the longitudinal arms, and the box body is fixed to the plate part; and
an spring component, with one end thereof fixed to the plate part, and the other end arranged at an end of the shaft, fixed by the longitudinal arms and the box body in the length direction of the shaft.

12. The comb plate according to claim 11, wherein the spring component is constructed as a torsion spring, where body of the torsion spring is arranged at an end of the shaft.

13. The comb plate according to claim 9, wherein the plurality of rollers are spaced at least one tooth apart from each other, and front parts of the teeth corresponding to positions of the rollers are configured to partially expose the rollers.

14. The comb plate according to claim 9, wherein the front parts of the teeth between the rollers are each provided with a concave part for accommodating the bracket.

15. A conveyor device, comprising:
a truss;
a conveyor belt comprising a plurality of steps; and
a first floor plate and a second floor plate arranged at both ends of the conveyor belt, wherein the first floor plate and the second floor plate are each provided with a comb plate according to claim 1 at a transition area with the steps.

16. The conveyor device according to claim 15, wherein the conveyor device is an escalator or a moving walk.
